(19) United States
(12) Patent Application Publication
(10) Pub. No.: US 2006/0042966 A1
(43) Pub. Date: Mar. 2, 2006

(54) Device for detecting deterioration of oil

(75) Inventors: Tetsuo Hariu, Kariya-city (JP); Kazuyuki Horie, Nagoya-city (JP); Takao Ban, Toyohashi-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/196,383

(22) Filed: Aug. 4, 2005

(30) Foreign Application Priority Data
Aug. 24, 2004 (JP) 2004-244247

(51) Int. Cl. G01N 27/26

(52) U.S. Cl. 205/787.5; 204/433

(57) ABSTRACT

A device for detecting deterioration degree of oil is composed of an electrode unit in a cylindrical coil shape and a detector circuit connected to the electrode unit. The electrode unit is composed of a first electrode plate and a second electrode plate, both wound in a coil shape with an insulating layer disposed therebetween. The electrode unit is dipped in oil, and a potential difference between the electrode plates is measured by the detector circuit. The oil deterioration degree is detected based on the potential difference that varies according to a pH level of the oil. A distance between the first and the second electrode plates is kept small and precise to enhance accuracy in detecting oil deterioration without making the detector size large.

### CROSS-REFERENCE TO RELATED APPLICATION

This application is based upon and claims benefit of priority of Japanese Patent Application No. 2004-244247 filed on Aug. 24, 2004, the content of which is incorporated herein by reference.

### BACKGROUND OF THE INVENTION

1. Field of the Invention

The present invention relates to a detector for detecting deterioration of oil used in an automobile vehicle as lubrication oil or control oil.

2. Description of Related Art

Examples of oil deterioration detectors are disclosed in JP-A-2002-243681 and JP-A-2003-166969. The detector detects deterioration of oil contained in an oil pan, for example. The detector includes a reference electrode, a potential of which is maintained at a constant level regardless of a pH level of the oil, a detector electrode, a potential of which varies according to the pH level of the oil, and a detector circuit for detecting a potential difference between both electrodes. Since the pH level of the oil, which is represented by an electrical potential difference between both electrodes dipped in the oil, varies according to a deterioration degree of the oil, the oil deterioration is detected by measuring the potential difference.

The resistance between both electrodes has to be made as low as possible to attain a high accuracy in detection. The resistance becomes lower in proportion to a facing area of both electrodes and in inverse proportion to a distance between both electrodes. The reference electrode and the detecting electrode are positioned to face each other and insulated from each other. Both electrodes are wound in a cylindrical coil shape, forming a pair of electrodes. Plural pairs of the electrodes are combined to form a cylindrical shape, and the plural reference electrodes, and the plural detecting electrodes are electrically connected, respectively. In the conventional detector, the facing area of the electrodes is increased by providing plural pairs of electrodes.

Further, JP-A-2002-243681 shows slits formed in both electrodes. Both electrodes are well exposed to the oil because the oil flows through the slits. JP-A-2003-166969 discloses that the slits are formed by raising fins from the electrode plate and that the fins are utilized to increase the facing area of the electrodes.

It has been required to save the space in an engine compartment and to make the oil deterioration detector compact in size. In the conventional detector, however, it has been difficult to make the detector compact because plural pairs of electrodes are coaxially disposed to form a cylindrical shape. It has been difficult to make the detector small in size without increasing the resistance between the reference electrode and the detecting electrode.

### SUMMARY OF THE INVENTION

The present invention has been made in view of the above-mentioned problem, and an object of the present invention is to provide an improved oil deterioration detector which is made compact without increasing the resistance between the electrodes. Another object of the present invention is to provide a method of manufacturing such a detector.

The oil deterioration detector is composed of a first electrode plate, a second electrode plate and a detector circuit. The first and the second electrode plates are disposed to face each other with a predetermined electrode distance therebetween, and both electrodes are insulated from each other. Both electrodes are wound in a cylindrical coil shape, forming an electrode unit. The electrode unit is dipped in oil contained in an oil pan. The oil may serve as lubricating oil of an internal combustion engine or as control oil used in various control devices.

The first electrode plate functions as a reference electrode, an electrical potential of which is constant regardless of a pH level of the oil. The second electrode plate functions as a detecting electrode, an electrical potential of which varies according to the pH level of the oil. The detector circuit connected to the electrodes detects a potential difference between the first electrode plate and the second electrode plate. Thus, deterioration degree of the oil is detected based on the pH level of the oil.

Preferably, an insulating layer is disposed between the first electrode plate and the second electrode plate to keep the electrode distance small and precise. Preferably, through-holes are formed in both electrode plates so that the electrodes are well exposed to the oil. The insulating layer may be made of oil-permeable composite fibers or oil-permeable porous resin. Alternatively, the insulating layer may be made of a resin material that does not permeate oil. When the insulating layer is made of a non-oil permeable material, the insulation layer is formed in plural stripes discretely positioned between the first electrode plate and the second electrode plate. The non-oil permeable insulating layer may be formed in plural dots. In this manner, the electrodes are always exposed to the oil.

In a process of manufacturing the oil deterioration detector, a cap for maintaining a shape of the electrode unit wound in a cylindrical coil shape may be coupled to one axial end of the electrode unit. Then, the other axial end of the electrode unit is connected to an electrode holder to securely hold the electrode unit and to establish electrical connections.

According to the present invention, the electrode unit in a cylindrical coil shape is formed by winding one pair of the first electrode plate and the second electrode plate with an insulation layer disposed therebetween. Therefore, the distance between the first electrode plate and the second electrode plate can be made small and precise to enhance accuracy in detecting the oil deterioration without making the detector large in size. Other objects and features of the present invention will become more readily apparent from a better understanding of the preferred embodiment described below with reference to the following drawings.

### BRIEF DESCRIPTION OF THE DRAWINGS

FIG. 1 is a plan view showing an electrode unit as a first embodiment of the present invention used in an oil deterioration detector, viewed in direction I shown in FIG. 2;

FIG. 2 is a cross-sectional view showing an entire structure of the oil deterioration detector;

FIG. 3A is a perspective view showing a first electrode plate and a second electrode plate, both wound in a cylindrical coil shape;

FIG. 3B is a perspective view showing an electrode unit composed of the first electrode plate and the second electrode plate;

FIG. 4 is a plan view showing an electrode unit as a second embodiment of the present invention;

FIG. 5 is a partial plan view showing the electrode unit shown in FIG. 4 in an enlarges scale;

FIG. 6 is a plan view showing laminated layers forming the electrode unit shown in FIG. 4 before the layers are wound in a coil shape;

FIG. 7 is a plan view showing a flattened electrode plate and insulating layer stripes as a second embodiment of the present invention, viewed in direction VII shown in FIG. 6;

FIG. 8 is a plan view showing a flattened electrode plate and insulating layer stripes as a third embodiment of the present invention;

FIG. 9 is a plan view showing a flattened electrode plate and an insulating layer as a fourth embodiment of the present invention;

FIG. 10 is a plan view showing a flattened electrode plate and an insulating layer having round holes as a fifth embodiment of the present invention;

FIG. 11 is a plan view showing a flattened electrode plate and an insulating layer in a shape of discrete dots as a sixth embodiment of the present invention;

FIG. 12 is a plan view showing a flattened electrode plate and an oil-permeable insulating layer as a seventh embodiment of the present invention;

FIG. 13 is a plan view showing a flattened electrode plate and an insulating layer having small round holes as a modified form of the fifth embodiment;

FIGS. 14A-14D show a process of manufacturing the oil deterioration detector having an insulating layer between electrodes;

FIG. 15A is a side view showing a comparative example of an oil deterioration detector; and

FIG. 15B is a plan view showing the comparative example of an oil deterioration detector, viewed from a right side of FIG. 15A.

### DETAILED DESCRIPTION OF THE PREFERRED EMBODIMENTS

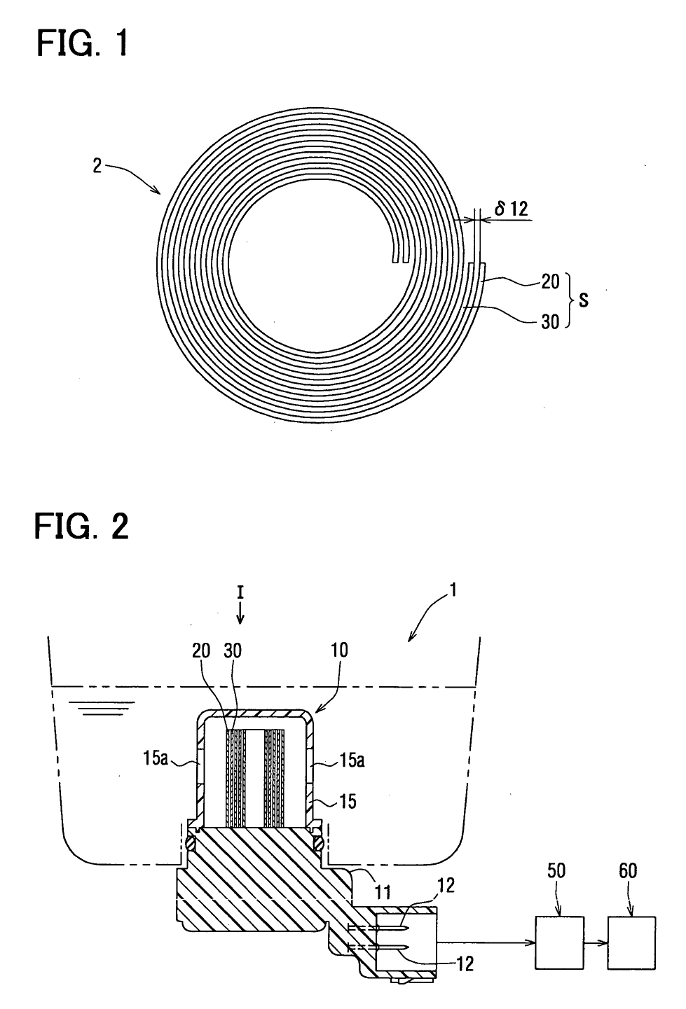

A first embodiment of the present invention will be described with reference to FIGS. 1-3. A device 1 for detecting deterioration of oil (referred to as an oil deterioration detector 1) includes a detecting element 10 that detects deterioration degree of lubricating oil or control oil contained in an oil pan or the like and a detector circuit 50 that detects an electric potential difference sensed by the detecting element 10. The detector circuit 50 is further connected to an evaluating circuit 60 that determines a degree of oil deterioration based on a signal sent from the detector circuit 50 and notifies a driver of its determination results by means of a warning lamp, a warning sound or the like when an oil deterioration level exceeds a predetermined level.

The detector element 10 includes a first electrode plate 20 and a second electrode plate 30. Both electrode plates are dipped in oil, and a deterioration degree of the oil is detected based on a potential difference between both electrode plates 20 and 30. The potential difference varies according to a pH level of the oil. That is, the detector element 10 functions as a battery generating a voltage representing a deterioration degree of the oil. It is also possible to structure the detector element 10 as a capacitor representing the deterioration degree of the oil.

The first electrode plate 20 is made of a metal, a potential of which is constant irrespective of a pH level of the oil, such as cobalt (Co), zinc (Zn), tin (Sn) or nickel (Ni) That is, the first electrode plate 20 functions as a reference electrode. In this particular embodiment, the first electrode plate 20 is made of zinc (Zn). On the other hand, the second electrode plate 30 is made of a metal, a potential of which varies according to the pH level of the oil, such as stainless steel (SUS), titanium (Ti), chromium (Cr). That is, the second electrode plate 30 functions as a detecting electrode. In this particular embodiment, the second electrode plate 30 is made of stainless steel (SUS).

As shown in FIG. 2, the first electrode plate 20 and the second electrode plate 30 are connected to an electrode holder 11. Terminals 12 led out from respective electrodes 20, 30 are exposed to an opening of the electrode holder 11 so that they can be connected to the detecting circuit 50. The detector element 10 is covered with a cover 15 having oil passages 15a and dipped into the oil contained in an oil pan. Both electrode plates 20, 30 are exposed to the oil because the oil in the oil pan flows into the cover 15 through the oil passages 15a. The first and the second electrode plates 20, 30 are wound in a cylindrical coil shape as shown in FIG. 1, forming an electrode unit 2.

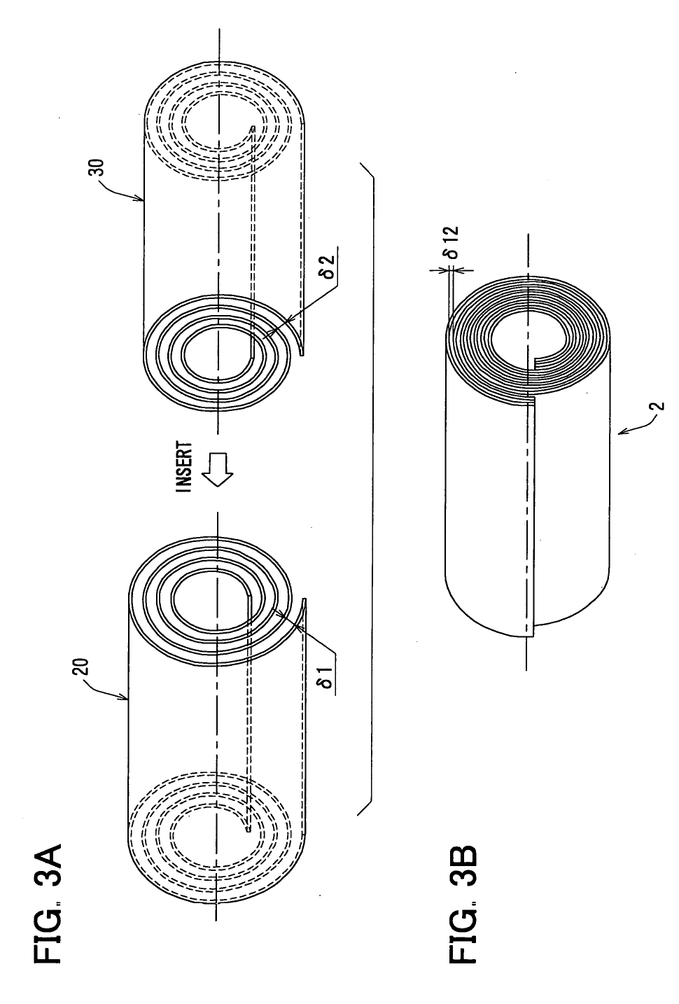

A method of manufacturing the electrode unit 2 will be described with reference to FIGS. 3A and 3B. The first electrode plate 20 is wound in a coil shape having a gap δ1 between layers. Similarly, the second electrode plate 30 is wound in a coil shape having a gap δ2 between layers. Then, the second electrode plate 30 is inserted into the first electrode plate 20 as shown in FIG. 3A, so that both electrode plates are coaxially positioned. Thus, the electrode unit 2 shown in FIG. 3B is formed. By inserting the second electrode plate 30 into the first electrode plate 20, a distance δ12 between the first electrode plate 20 and the second electrode plate 30 is formed. This distance δ12 may be maintained by inserting a jig into gaps each forming the distance δ12.

The oil enters into the electrode unit 2 through the electrode gaps forming the distance δ12 when the electrode unit 2 is dipped in the oil. Through-holes for further promoting oil penetration into the electrode unit 2 may be formed in the electrode plates 20, 30. In this manner, even if the distance δ12 is made considerably small, the electrodes 20, 30 are surely exposed to the oil. The distance δ12 has to be made as small as possible to reduce a resistance between the electrodes 20 and 30 because the potential difference between electrodes 20, 30 becomes smaller as the resistance becomes higher. A higher accuracy in detecting the oil deterioration is secured by making the potential difference between the electrodes higher.

To reduce the resistance between the electrodes, a facing area of both electrodes has to be made larger or the distance δ12 has to be made smaller. If the facing area is enlarged, the oil deterioration detector 1 becomes bulky. Therefore, it is desirable to make the distance δ12 smaller, which is attained in the present invention. To make the distance δ with a desired size, the gap δ1 between the first electrode layers is set: δ1=2×δ12+t2, where t2 is a thickness of the second electrode plate 30. The gap δ2 between the second electrode layers is set: δ2=2×δ12+t1, where t1 is a thickness of the first electrode plate 20. The second electrode plate 30 wound with the gap δ2 is coaxially inserted into the first electrode plate 20 wound with the gap δ1. Since the electrode unit 2 of the present invention is composed of only one pair of the electrode plates 20 and 30, as opposed to the conventional electrode unit composed of plural pairs, it is not necessary to make electrical connections among respective pairs. Only a pair of terminals 12 (refer to FIG. 2) is required for making electrical connection.

The following advantages are attained in the first embodiment described above. Since the electrode unit 2 is composed of only one pair of the first electrode plate 20 and the second electrode plate 30, the electrode distance 512 can be accurately formed between both electrode plates. Therefore, the distance δ12 can be made small, and the detector 1 can be made compact in size. Since one axial end of the electrode unit 2 is exposed to the oil, the oil can easily enter into the electrode gaps. Therefore, the electrodes are always exposed to the oil. Since the other axial end of the electrode unit 2 is connected to the electrode holder 11, rigidity of the oil deterioration detector 1 is enhanced, so that it can endure a high vibration of an automobile.

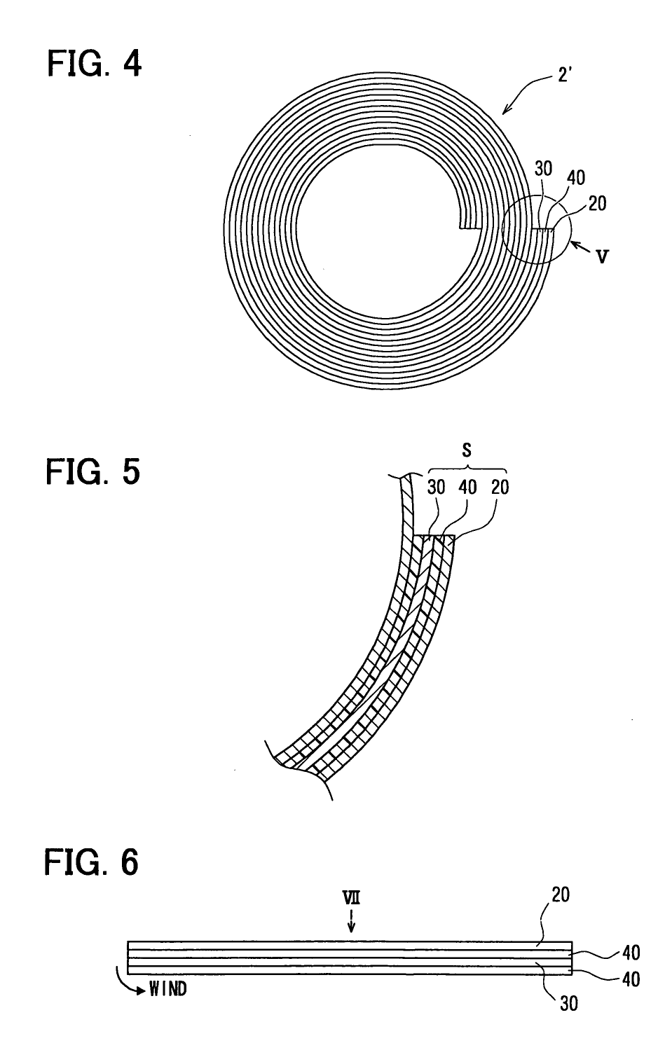

A second embodiment of the present invention will be described with reference to FIGS. 4-7. In this embodiment, stripes of an insulating layer 40 having a predetermined thickness δ12 are disposed in the electrode gaps (each having distance δ12). Other structures and functions are similar to those of the first embodiment.

The insulating layer 40 is made of a resin material such as polyamide-imide, a non-woven material such as glass fiber, a material for painting, or the like. In this particular embodiment, the insulating layer 40 is made of a resin material. As shown in FIGS. 4-6, the insulating layer 40 is disposed in the electrode gap between the first electrode plate 20 and the second electrode plate 30, forming an electrode structure S. The laminated layers are wound to form an electrode unit 2′ shown in FIG. 4.

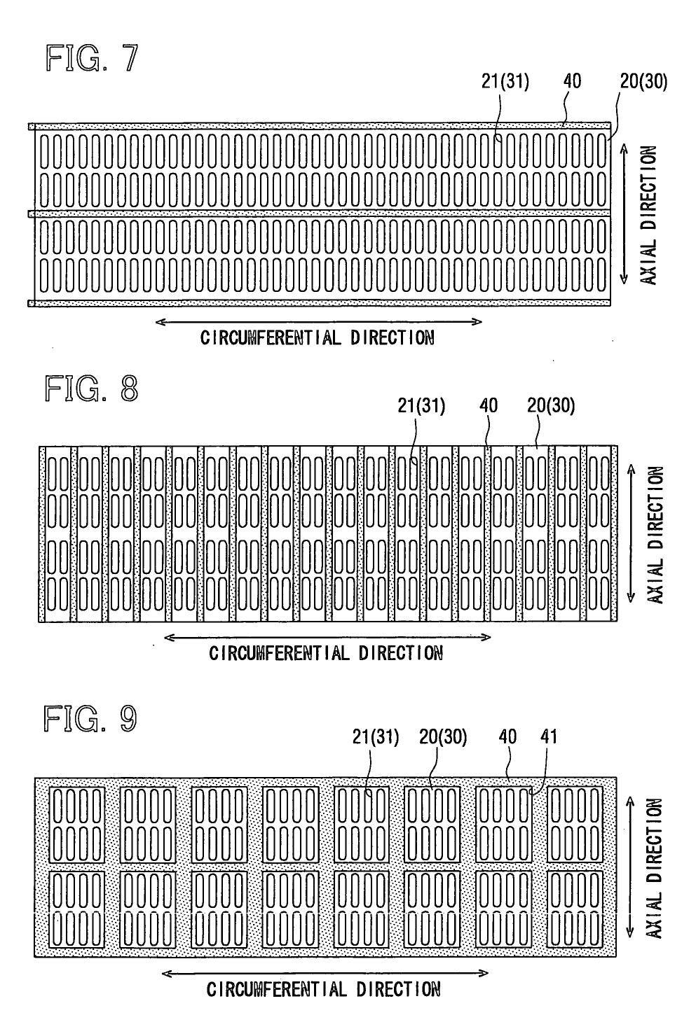

As shown in FIG. 7, the stripes of the insulating layer 40 are positioned at an upper end, a middle portion and a lower end of the electrode plates 20, 30. The stripes of the insulating layer 40 are extended along a circumferential direction of the electrode unit 2′. Oval through-holes 21 (31) having a longer axis in the axial direction of the electrode unit 2′ are formed in the electrode plates 20 (30), so that the oil flows through the through-holes 21 (31), and the electrodes are always exposed to the oil. The stripes of the insulating layer 40 are positioned not to close the through-holes 21 (31). Thus, the oil flows through the through-holes 21 (31) even if the insulating material is made of a resin material such as polyamide-imide through which the oil does not permeate. It is preferable to form the through-holes 21, 31 to face each other to facilitate oil communication therethrough. The number of the stripes of the insulating layer 40 is not limited to three, but it may be more than three. Some of the oval through-holes 21 (31) may be covered with the stripes as long as most of the through-holes 21 (31) are not covered.

The following advantages are attained in the second embodiment described above. Since the first and the second electrode plates 20, 30 are wound in a cylindrical coil shape with the stripes of the insulating layer 40 having a thickness δ12 disposed between the first electrode plate 20 and the second electrode plate 30, the electrode unit 2′ having the electrode distance δ12 is easily formed. Since the through-holes 21 (31) are formed on the electrodes 20, 30, and the stripes of the insulating layer 40 are positioned not to close the through-holes 21 (31), both electrode plates 20, 30 are well exposed to the oil. Since the facing area of the electrodes plates 20, 30 is separated into sections by the stripes of the insulating layer 40, a mechanical strength of the electrode unit 2 is secured even when one of the electrodes 20, 30 has a lower mechanical strength than the other.

A third embodiment of the present invention will be described with reference to FIG. 8. In this embodiment, the stripes of the insulating layer 40 are disposed to run in the axial direction of the electrode unit 2′, as opposed to those running in the circumferential direction in the second embodiment. Other structures and functions are similar to those of the second embodiment. The facing area of the electrode plates 20, 30 are separated into small sections by the stripes of the insulating layer 40 running in the axial direction. Accordingly, the mechanical strength of the electrode unit 2′ is further enhanced.

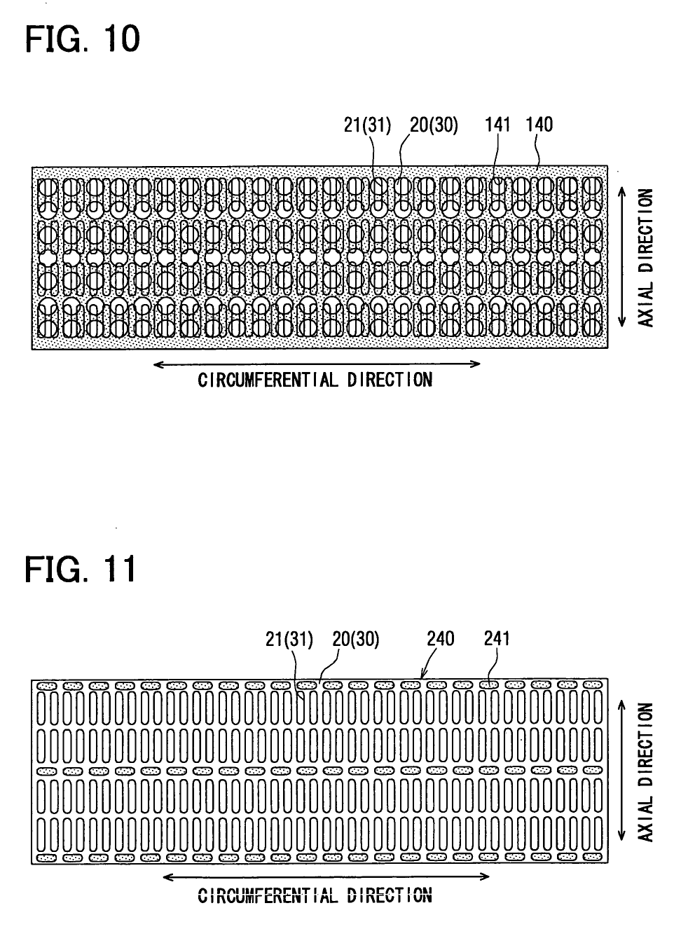

FIG. 9 shows a fourth embodiment of the present invention. In this embodiment, the stripes of the insulating layer 40 are disposed in both the circumferential direction and the axial direction, forming plural squares 41 on the electrodes 20 (30). The stripes may be disposed to form polygons other than squares. FIG. 10 shows a fifth embodiment of the present invention. In this embodiment, the insulating layers 140 having many round holes 141 is disposed between the first electrode plate 20 and the second electrode plate 30. The round holes 141 are positioned to communicate with at least part of the through-holes 21 (31) of the electrode plates 20 (30). FIG. 11 shows a sixth embodiment of the present invention. In this embodiment, the insulation layer 240 is disposed between the electrode plates 20 and 30 in a form of plural dots 241. The dots 241 of the insulating layer 240 form an upper line, a middle line and a lower line along the circumferential direction of the electrode unit 2′.

The patterns of the insulating layer (40, 140, 240) shown in FIGS. 9-11 may be formed by various ways. For example, the patterns may be printed on the electrode plates by means of pattern printing or hot press printing. Alternatively, the patterns may be formed by molding insulating resin on the electrode plates, or by painting insulating resin resolved in solvent. The electrode plates 20, 30 having the insulation layer pattern thus formed are wound into a coil shape, forming the electrode unit 2′ shown in FIG. 4.

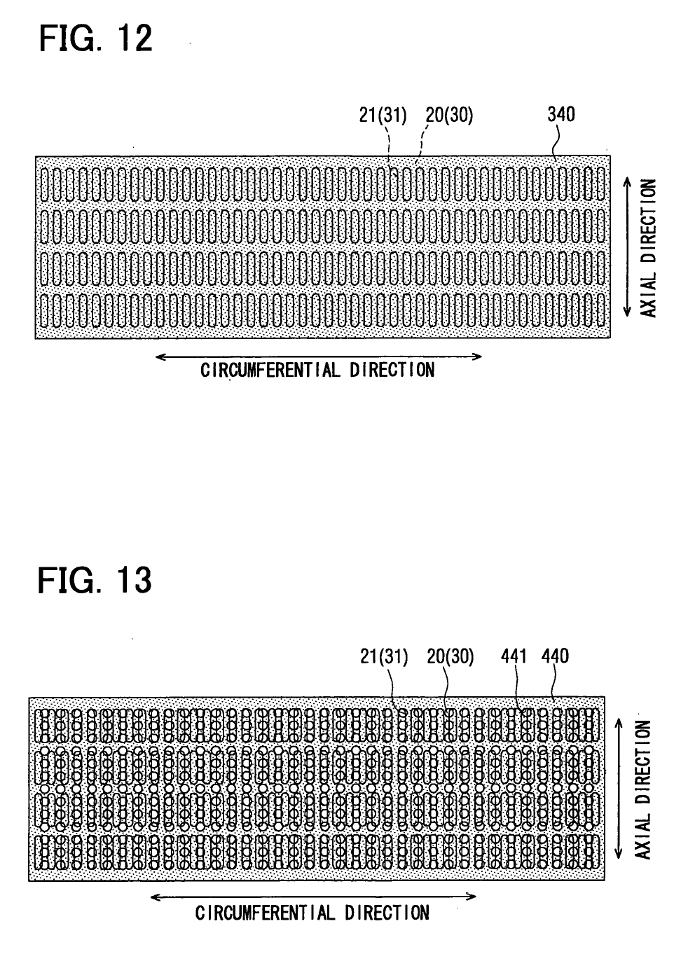

A seventh embodiment of the present invention will be described with reference to FIG. 12. In this embodiment, the insulating layer 340 is made of a fiber material, such as glass fibers, through which oil is permeable. Since the insulating layer 340 is made of an oil-permeable material, it is not necessary to form holes in the insulating layer 340. The insulating layer 340 is disposed between electrode plates 20, 30 to cover an entire area or part of the electrode plates 20, 30.

Since the insulating layer 340 is oil-permeable, the through-holes 21 (31) formed in the electrode plates may be covered with the insulating layer 340. The electrode plates 20, 30 are always exposed to the oil regardless of whether the through-holes 21 (31) are covered with the insulating layer 340 or not. The insulating layer 340 made of a fiber material may be replaced with an insulating layer made of a porous resin material through which the oil is permeable.

The fifth embodiment shown in FIG. 10 may be modified to a form shown in FIG. 13. In this modified form, the round holes 141 in the fifth embodiment are replaced with many small holes 441 formed on the insulating layer 440. The insulating layer 440 may be made of resin, and the resin-made layer may be molded on either the first electrode plate 20 or the second electrode plate 30. By forming the insulating resin layer on the electrode plate, the electrode plate can be easily wound together with the insulating resin layer into a coil shape.

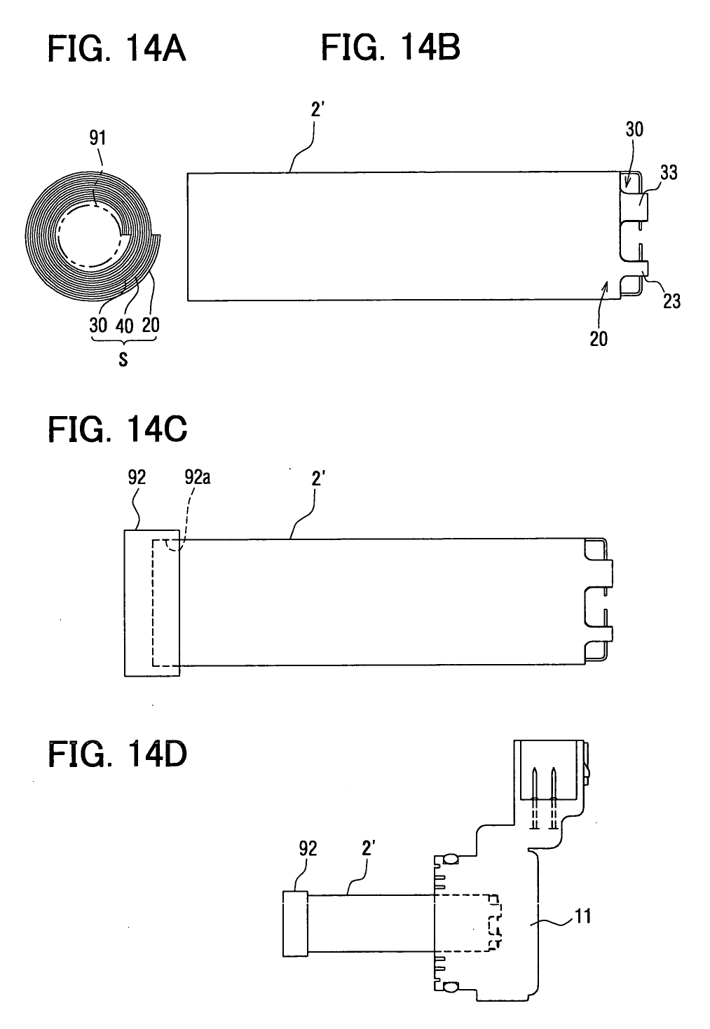

A method of manufacturing the oil deterioration detector having the electrode unit 2′ that includes the insulating layer disposed between the first and the second electrode plates 20, 30 will be briefly described with reference to FIGS. 14A-14D. In a manufacturing step shown in FIG. 14A, the first electrode plate 20 and the second electrode plate 30, with the insulating layer 40 disposed therebetween, are wound around a winding pillar 14A. Thus, the electrode unit 2′ having an electrode structure S is formed. In case the insulating layer 40 is printed or formed on either the first electrode plate 20 or the second electrode plate 30, the electrodes 20, 30 are simply laminated and wound in a coil shape. A side view of the electrode unit 2′ is shown in FIG. 14B. Terminals 23, 33 are led out from the first electrode plate 20 and the second electrode plate 30, respectively.

In the manufacturing step shown in FIG. 14C, a cap 92 having a depression 92a is coupled to an axial end of the electrode unit 2′. The cap 92 is coupled to the axial end of the electrode unit 2′ to prevent the diameter of the electrode unit 2′ from being enlarged and to maintain the electrode distance δ12. In the manufacturing step shown in FIG. 14D, the electrode holder 11 is connected to the other axial end of the electrode unit 2′ with adhesive. The cap 92 may be removed after the electrode unit 2′ is connected to the electrode holder 11 if the axial end where the cap 92 is coupled is not likely to expand.

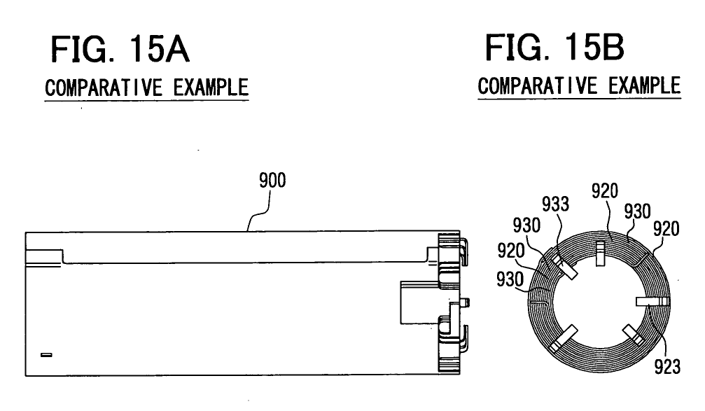

A comparative example of the electrode unit 900 is shown in FIGS. 15A and 15B. In this comparative example, plural pairs of the first electrode plate 920 and the second electrode plate 930 are coaxially disposed in a cylindrical coil shape. In this case, the plural first electrode plates 920 are electrically connected by a connecting portion 923, and the plural second electrode plates 930 are electrically connected by another connecting portion 933. As opposed to this comparative example, such connecting portions are not necessary in the electrode unit 2′ of the present invention. Accordingly, the manufacturing process is simplified.

While the present invention has been shown and described with reference to the foregoing preferred embodiments, it will be apparent to those skilled in the art that changes in form and detail may be made therein without departing from the scope of the invention as defined in the appended claims.

What is claimed is:

1. A device for detecting deterioration of oil, the device comprising:
a first electrode plate;
a second electrode plate disposed to face the first electrode plate and insulated from the first electrode plate, both electrode plates being wound in a cylindrical coil shape; and
a detector circuit for detecting an electric potential difference between the first electrode plate and the second electrode plate when both electrode plates are dipped in oil.

2. The detecting device as in claim 1, wherein:
an insulating layer is disposed between the first electrode plate and the second electrode plate.

3. The detecting device as in claim 2, wherein:
the insulating layer is wound in a cylindrical coil shape together with the first and the second electrode plates, forming an electrode unit.

4. The detecting device as in claim 3, wherein:
the insulating layer is formed in plural stripes that are discretely positioned between the first and the second electrode plates.

5. The detecting device as in claim 4, wherein:
the stripes of the insulating layer are positioned along a circumferential direction of the electrode unit.

6. The detecting device as in claim 4, wherein:
the stripes of the insulating layer are positioned along an axial direction of the electrode unit.

7. The detecting device as in claim 4, wherein:
the stripes of the insulating layer are positioned along both a circumferential direction and an axial direction of the electrode unit.

8. The detecting device as in claim 3, wherein:
the insulating layer is made of composite fibers through which the oil permeates.

9. The detecting device as in claim 3, wherein:
the insulating layer is made of a porous resin material through which the oil permeates.

10. The detecting device as in claim 3, wherein:
a plurality of holes are formed in the insulating layer.

11. The detecting device as in claim 3, wherein:
the insulating layer is made of resin which is molded together with either the first electrode plate or the second electrode plate.

12. The detecting device as in claim 1, wherein:
through-holes are formed in the first and the second electrode plates, and the through-holes in the first electrode plate are positioned to substantially face the through-holes in the second electrode plate.

13. The detecting device as in claim 1, wherein:
one axial end of the first and the second electrode plates wound in a cylindrical coil shape is connected to an electrode holder.

14. A method of manufacturing the detecting device defined in claim 3, the method comprising:
winding the first electrode plate and the second electrode plate in a cylindrical coil shape together with the insulating layer disposed between the first and the second electrode plates, thereby forming an electrode unit;
coupling a cap to one axial end of the electrode unit to thereby maintain a shape of the axial end; and
connecting an electrode holder having connecting terminals to the other axial end of the electrode unit.
